(19) United States
(12) Patent Application Publication
(10) Pub. No.: US 2015/0077231 A1
(43) Pub. Date: Mar. 19, 2015

(54) METHOD, APPARATUS, AND SYSTEM FOR INTELLIGENTLY CONTROLLING DEVICE, AND PLUG-AND-PLAY DEVICE

(71) Applicant: Huawei Technologies Co., Ltd., Shenzhen (CN)

(72) Inventors: Zhi KANG, Hangzhou (CN); Ke FENG, Hangzhou (CN); Bo HUANG, Hangzhou (CN)

(21) Appl. No.: 14/546,764

(22) Filed: Nov. 18, 2014

Related U.S. Application Data
(63) Continuation of application No. PCT/CN2013/084387, filed on Sep. 27, 2013.

(30) Foreign Application Priority Data
May 17, 2013 (CN) 201310185748.9

(51) Int. Cl. G08C 17/02; G08C 19/16

(52) U.S. Cl. CPC G08C 17/02; G08C 19/16; G08C 2201/30; G08C 2201/51; G08C 2201/42
USPC 340/12.54

(57) ABSTRACT

This application discloses an intelligent controlling method and a system. The system includes a controlling device, a controlled device and an interaction device. The controlling device acquires parameter information of the controlled device. The parameter information reflects a current running state of the controlled device. The controlling device generates a graphical user interface (GUI) which integrates the acquired parameter information, and sends the GUI in a form of a data stream to the interaction device. The interaction device displays the GUI and the parameter information, receives an input by a user that includes an instruction, and sends a signal to the controlling device. The controlling device parses the signal to obtain the instruction, and sends the instruction to the controlled device, so that the controlled device performs a control operation according to the instruction.

### CROSS-REFERENCE TO RELATED APPLICATIONS

This application is a continuation of International Patent Application No. PCT/CN2013/084387, filed on Sep. 27, 2013, which claims priority to Chinese Patent Application No. 201310185748.9, filed on May 17, 2013, both of which are hereby incorporated by reference in their entireties.

### TECHNICAL FIELD

The present application relates to Internet technologies, and in particular, to intelligently controlling a device.

### BACKGROUND

In daily life, intelligently controlling of an appliance (hereinafter referred to as “device”), such as a refrigerator, a washing machine, and a television set, can effectively reduce manual operation and improve usage experience of such device. For example, after a user sets a temperature range on a refrigerator, the refrigerator, in a running process, can intelligently detect a temperature and adjust the temperature to be within the temperature range. In this way, the user does not need to perform manual control, and therefore usage experience of the refrigerator is effectively improved. For another example, a user may set a running time of a washing machine at an off-peak time (usually at night), so that the washing machine uses the electricity at the off-peak rate. In this way, the user does not need to manually control the running of the washing machine during the off-peak time, and therefore usage experience of the washing machine is effectively improved.

Although the foregoing appliances or devices are intelligent, it is still required that a user performs related intelligent control. These devices are generally equipped with an intelligent chip, a display screen, and complex keys, requiring a user to have relatively high intelligent control skills, causing great inconvenience to a user at the time of performing the intelligent control and low utilization of the intelligent features.

### SUMMARY

Embodiments of the present application disclose a method, an apparatus, and a system for intelligently controlling a device. The embodiments of the present application also provide a plug-and-play device, which can perform intelligent control on a device simply, conveniently, and fast.

In a first aspect of the application, a method, performed by a controlling device, is provided. The method includes: acquiring parameter information of a controlled device, wherein the parameter information reflects a current running state of the controlled device; generating a graphical user interface (GUI), wherein the acquired parameter information is integrated in the GUI; converting the GUI into a data stream; and sending the data stream to an interaction device for displaying the GUI and the parameter information on the interaction device. The method further includes receiving a signal from the interaction device, wherein the signal is generated based on an input by a user on the interaction device for performing a control operation on the controlled device; parsing the signal to obtain an instruction; and sending the instruction to the controlled device, so that the controlled device performs the control operation according to the instruction.

In the above method, the GUI and the parameter information may be displayed on an interactive graphical display unit of the interaction device. The input by the user may be received on the interactive graphical display unit and the input may include an instruction for adjusting the parameter information of the controlled device. The control operation may include an operation of adjusting the parameter information of the controlled device.

In the above method, parsing the signal to obtain an instruction may include converting the signal into an input event matching with the user input on the interaction device, and parsing the input event to obtain the instruction.

The above method may further include acquiring type information of the controlled device; sending identity information of the controlling device and the type information of the controlled device to a cloud server; receiving a device control program corresponding to the type information of the controlled device after the cloud server determines through an authentication that the identity information of the controlling device is valid; and installing the device control program in the controlling device.

The above method may further include sending a software upgrade request which carries the identity information of the controlling device and version information of the device control program to the cloud server; receiving an upgrade packet of the device control program, wherein the upgrade packet of the device control program is sent by the cloud server after the cloud server determines that the device control program installed in the controlling device is not the latest version; and upgrading the device control program by using the upgrade packet.

The above method may further include receiving a connection establishment request from the interaction device; and sending a connection completion response to the interaction device so as to establish a connection between the controlling device and the interaction device.

In the above method, acquiring the parameter information of the controlled device may include sending a parameter information query to the controlled device; and receiving the parameter information of the controlled device from the controlled device in response to the parameter information query.

In the above method, converting the GUI into a data stream may include encoding the GUI into an encoded video data stream; and sending the data stream to an interaction device for displaying the GUI and the parameter information on the interaction device may include sending the encoded video data stream to the interaction device, so that the interaction device decodes the encoded video data stream, and renders the decoded video data stream into the GUI for displaying on the interaction device.

In a second aspect of the application, a controlling device is provided. The controlling device includes: a first connection interface for connecting to a controlled device; a second connection interface for connecting to an interaction device; a memory unit for storing program codes; and at least one processor, executing program codes stored in the memory unit. The first connection interface is configured to receive parameter information of the controlled device, wherein the parameter information reflects a current running state of the controlled device. The processor is configured to generate a graphical user interface (GUI) which integrates the parameter information, and convert the GUI into a data stream. The second connection interface is configured to send the data stream to the interaction device for displaying the GUI and the parameter information on the interaction device, and to receive a signal from the interaction device, wherein the signal is generated based on an input by a user on the interaction device for performing a control operation on the controlled device. The processor is further configured to parse the signal to obtain an instruction. The first connection interface is further configured to send the instruction to the controlled device, so that the controlled device performs the control operation according to the instruction.

In a third aspect of the application, a system is provided. The system includes a controlling device, a controlled device, and an interaction device. The controlling device is configured to acquire parameter information of the controlled device, generate a graphical user interface (GUI), convert the GUI into a data stream, and send the data stream to the interaction device, wherein the parameter information reflects a current running state of the controlled device, and the parameter information is integrated in the GUI. The interaction device is configured to receive the data stream, display the GUI and the parameter information on the interaction device, receive a user input comprising an instruction for performing a control operation on the controlled device, and send a signal comprising the user input to the controlling device. The controlling device is further configured to receive the signal from the interaction device, parse the signal to obtain the instruction, and send the instruction to the controlled device. The controlled device is configured to perform the control operation according to the instruction.

The above system may further include a cloud server. When the controlling device acquires type information of the controlled device, and sends the identity information of the controlling device and the type information of the controlled device to the cloud server, the cloud server authenticates the identity of the controlling device, and sends a device control program corresponding to the type information of the controlled device. The controlling device installs the device control program.

By implementing the embodiments of the present application, a user does not need to perform related intelligent control on a controlled device by using an intelligent chip, a display screen, and complex keys integrated in the controlled device; and the user can perform intelligent control on the controlled device only by triggering, on an interaction device, an input event based on parameter information included in a graphical interaction interface displayed on the interaction device. In this way, intelligent control on the controlled device can be performed simply, conveniently, and fast.

In addition, by implementing the present application, the controlled device only needs to have a basic function actuator and does not need to be integrated with an intelligent chip, a display screen, and complex keys. In this way, the user is allowed to have a relatively low intelligent control technology threshold, which greatly reduces a barrier to a user performing intelligent control, increases actual utilization of the controlled device, and benefits promotion and popularization of the controlled device.

Further, by implementing the present application, the user can trigger, by using the interaction device, the controlled device to perform an intelligent operation at a fixed time and independently, so that the user no longer relies on the controlled device, thus the present application has good adaptability.

### BRIEF DESCRIPTION OF DRAWINGS

In order to present the technical solutions in the embodiments of the present application more clearly, the following briefly introduces the accompanying drawings used in describing the embodiments.

FIG. 1 is a flowchart of a method for intelligently controlling a device according to an embodiment of the present application;

FIG. 2 is a schematic diagram of a network architecture for intelligently controlling a device according to an embodiment of the present application;

FIG. 3 is a flowchart of another method for intelligently controlling a device based on the network architecture shown in FIG. 2 according to an embodiment of the present application;

FIG. 4 is a schematic diagram of a network architecture for upgrading a program according to an embodiment of the present application;

FIG. 5 is a flowchart of a method for downloading a device control service program to a controlling device by using the network architecture shown in FIG. 4 according to an embodiment of the present application;

FIG. 6 is a flowchart of a method for updating a device identification service program to a controlling device by using the network architecture shown in FIG. 4 according to an embodiment of the present application;

FIG. 7 is a schematic diagram of a network architecture for a communication connection according to an embodiment of the present application;

FIG. 8 is a simplified block diagram of an apparatus for intelligently controlling a device according to an embodiment of the present application;

FIG. 9 is a simplified block diagram of another apparatus for intelligently controlling a device according to an embodiment of the present application;

FIG. 10 is a simplified block diagram of another apparatus for intelligently controlling a device according to an embodiment of the present application;

FIG. 11 is a schematic drawing of a plug-and-play device according to an embodiment of the present application; and

FIG. 12 is a structural diagram of a system for intelligently controlling a device according to an embodiment of the present application.

### DESCRIPTION OF EMBODIMENTS

The following clearly describes the technical solutions in the embodiments of the present application with reference to the accompanying drawings in the embodiments of the present application. Apparently, the described embodiments are merely a part rather than all of the embodiments of the present application. All other embodiments obtained by a person of ordinary skill in the art based on the embodiments of the present application without creative efforts shall fall within the protection scope of the present application.

Embodiments of the present application provide a method, an apparatus, and a system for intelligently controlling a device. Intelligently controlling of the device can be performed simply, conveniently, and fast. The following describes each of the embodiments in detail.

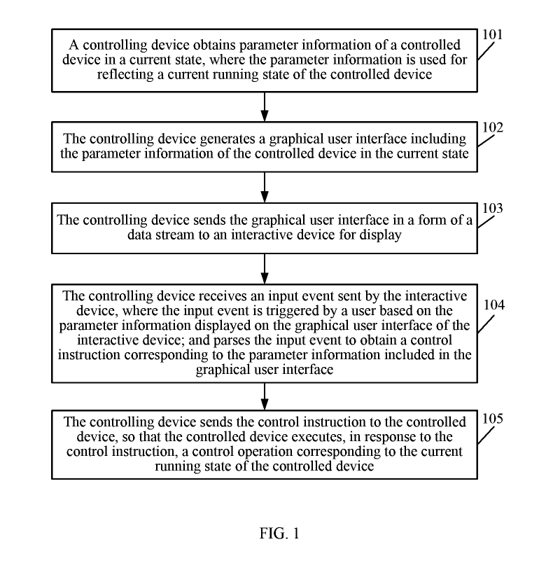

FIG. 1 is a flowchart of a method for intelligently controlling a device according to an embodiment of the present application. In order to implement intelligent control on a controlled device and provide a user-friendly graphical interaction interface, the embodiment of the present application introduces two types of devices, an interaction device and a controlling device. It should be noted that in the embodiment of the present application, the controlled device may be a common intelligent device or may also be an ordinary non-intelligent device (such as an ordinary non-intelligent refrigerator, a non-intelligent washing machine, or a non-intelligent television). When the controlled device is an ordinary non-intelligent device, the controlled device is not only integrated with a basic function actuator, but also should be integrated with an interface capable of communicating and interacting with the controlling device, such as, a standard universal serial bus (USB) interface. The controlling device may be a fixed or portable intelligent terminal. The controlling device not only needs to have an interface (such as a USB interface) for communicating and interacting with the controlled device, but also needs to have a capability of communicating and interacting with the interaction device. For example, the controlling device and the interaction device can access a same local area network or home network through Wi-Fi, so that the controlling device can communicate and interact with the interaction device through Wi-Fi. The interaction device may also be a portable intelligent terminal having a Wi-Fi capability, such as a mobile phone, a tablet computer, a personal computer (PC), or another mobile Internet device (MID), which is not limited in the embodiment of the present application.

As shown in FIG. 1, the method for intelligently controlling a device disclosed in the embodiment of the present application may include the following steps.

101: A controlling device acquires parameter information of a controlled device in a current state, where the parameter information reflects a current running state of the controlled device.

In an embodiment, after the controlling device and the controlled device establish a connection through a standard USB interface, the controlling device may send a parameter information query to the controlled device. The controlled device sends the parameter information of the controlled device in the current state to the controlling device in response to the parameter information query.

In another embodiment, after the controlling device and the controlled device establish a connection through a standard USB interface, the controlled device may also proactively send the parameter information of the controlled device in the current state to the controlling device, manners of which are not limited in the embodiment of the present application.

In the embodiment of the present application, the parameter information of the controlled device in the current state is generally related to a type of the controlled device. For example, if the controlled device is a refrigerator, the parameter information of the controlled device in the current state may include a temperature, a refrigeration mode, a lighting mode of the refrigerator in a current running state, even types or quantities of food in the refrigerator, or the like. For another example, if the controlled device is a washing machine, the parameter information of the controlled device in the current state may include a set washing time, a washing mode (such as standard washing or quick washing) of the washing machine in a current running state, or the like. For still another example, if the controlled device is a television, the parameter information of the controlled device in the current state may include a set startup time, a default play channel, a voice volume, of the television in a current running state, or the like.

102: The controlling device generates a graphical interaction interface including the parameter information of the controlled device in the current state.

In an embodiment, the controlling device may encapsulate the parameter information of the controlled device in the current state onto a graphical interaction interface, so as to generate the graphical interaction interface including the parameter information of the controlled device in the current state.

103: The controlling device sends the graphical interaction interface in a form of a data stream to an interaction device for display.

In an embodiment, the controlling device may encode the graphical interaction interface into a video stream, and send the video stream to the interaction device. The interaction device decodes the video stream and renders the decoded video stream into the graphical interaction interface including the parameter information of the controlled device in the current state.

104: The controlling device receives an input event sent by the interaction device, where the input event is triggered by a user based on the parameter information displayed on the graphical interaction interface of the interaction device; and parses the input event to obtain a control instruction corresponding to the parameter information included in the graphical interaction interface.

In the embodiment of the present invention, the controlling device may convert the input event into an input event matching with the graphical interaction interface generated by the controlling device, and parse the input event obtained through conversion to obtain the control instruction corresponding to the parameter information included in the graphical interaction interface.

For example, if the input event sent by the interaction device and received by the controlling device is triggered (such as, triggered through a gesture) by a user based on a temperature parameter that is of a refrigerator in a current state and included in the graphical interaction interface, the controlling device may parse the input event (that is, the gesture), so as to obtain a control instruction corresponding to the temperature parameter that is of the refrigerator in the current state and included in the graphical interaction interface.

105: The controlling device sends the control instruction to the controlled device, so that the controlled device performs, in response to the control instruction, a control operation corresponding to the current running state of the controlled device.

The performing a control operation corresponding to the current running state of the controlled device includes performing an adjustment corresponding to the parameter information included in the graphical interaction interface.

For example, if the controlling device obtains, in the foregoing step 104, the control instruction corresponding to the temperature parameter that is of the refrigerator in the current state and included in the graphical interaction interface, the controlling device may send the control instruction to the controlled device, so that the controlled device performs, in response to the control instruction, an adjustment (such as increase or decrease) of the temperature parameter that is of the refrigerator in the current state and included in the graphical interaction interface, so as to implement intelligent control on the temperature of the refrigerator in the current state.

For another example, if the controlling device obtains, in the foregoing step 104, a control instruction corresponding to a set washing time that is of a washing machine in a current state and included in the graphical user interface, the controlling device may send the control instruction to the controlled device, so that the controlled device performs, in response to the control instruction, an adjustment (such as postponing or bringing forward the washing time) of the set washing time that is of the washing machine in the current state and included in the graphical interaction interface, so as to implement intelligent control on the set washing time of the washing machine in the current state.

By implementing the method described in FIG. 1, a user does not need to perform intelligent control on a controlled device by using an intelligent chip, a display screen, and/or complex keys integrated in the controlled device. The user can perform intelligent control on the controlled device by triggering, on an interaction device, a gesture instruction corresponding to parameter information included in a graphical interaction interface displayed on the interaction device. In this way, intelligent control on the controlled device can be performed simply, conveniently, and fast.

In addition, by implementing the method described in FIG. 1, the controlled device only needs to have a basic function actuator and does not need to be integrated with an intelligent chip, a display screen, and complex keys. In this way, the user is allowed to have a relatively low intelligent control technology threshold, which significantly reduces a barrier to a user performing intelligent control, increases actual utilization of the controlled device, and benefits promotion and popularization of the controlled device.

Further, by implementing the method described in FIG. 1, the user can trigger, by using the interaction device, a controlled terminal to perform an intelligent operation at a fixed time and independently, so that the user no longer relies on the controlled device, thus the present application has good adaptability.

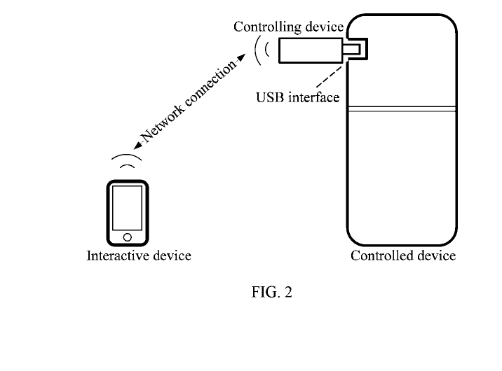

FIG. 2 is a schematic diagram of a network architecture for intelligently controlling a device according to an embodiment of the present application. In the network architecture shown in FIG. 2, a controlling device can establish a communication connection to an interaction device through a network connection (which includes but is not limited to a wireless connection or a wired connection, such as, Wi-Fi). For example, the controlling device and the interaction device may each access, through Wi-Fi, a local area network where a wireless router is located, so that the controlling device can establish a communication connection to the interaction device through a wireless network connection. In the network architecture shown in FIG. 2, the controlling device establishes a connection to a controlled device (such as, a refrigerator) through a USB interface. As a control center for intelligently controlling a device, the controlling device may have an intelligent operating system such as Android™, and a device control service program for performing device control can run on the intelligent operating system, so as to perform the method for intelligently controlling a device disclosed in the embodiment of the present application.

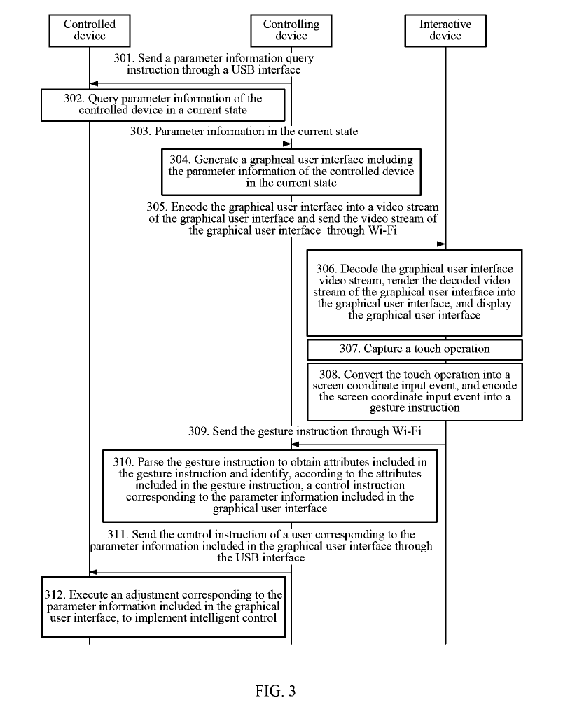

FIG. 3 is a flowchart of another method for intelligently controlling a device based on the network architecture shown in FIG. 2 according to an embodiment of the present application. As shown in FIG. 3, the method for intelligently controlling a device may include the following steps.

301: After establishing a connection to a controlled device (such as, a refrigerator) through a USB interface, a controlling device sends a parameter information query to the controlled device through the USB interface.

302: The controlled device queries parameter information of the controlled device in a current state in response to the parameter information query sent by the controlling device.

The parameter information query is used for instructing the controlled device to query the parameter information of the controlled device in the current state.

For example, if the controlled device is a refrigerator, the parameter information of the controlled device in the current state may include a temperature parameter, a refrigeration mode parameter, a lighting mode parameter of the refrigerator in the current state, even types or quantities of food in the refrigerator, or the like.

303: After packaging the parameter information of the controlled device in the current state, the controlled device sends the packaged parameter information to the controlling device through the standard USB interface.

304: The controlling device receives the parameter information of the controlled device in the current state which is sent by the controlled device, and generates a graphical interaction interface including the parameter information of the controlled device in the current state.

305: The controlling device encodes the graphical interaction interface including the parameter information of the controlled device in the current state into a video stream, and sends the video stream to an interaction device through Wi-Fi.

306: After receiving the video stream of the graphical interaction interface sent by the controlling device, the interaction device decodes the video stream, renders the decoded video stream into the graphical interaction interface including the parameter information of the controlled device in the current state, where the graphical interaction interface is displayed on a display unit (such as a screen) of the interaction device.

307: The interaction device captures a touch operation, which is performed by a user based on the parameter information included in the graphical interaction interface.

308: The interaction device converts the captured touch operation, which is performed by the user based on the parameter information included in the graphical interaction interface, into a screen coordinate input event, and encodes the screen coordinate input event into a gesture triggered by the user based on the parameter information included in the graphical interaction interface.

Content of the gesture triggered by the user based on the parameter information included in the graphical interaction interface may include attributes such as a touch operation type (such as, tap or flick), a touch operation area (including a touch operation start point and end point), a touch operation time, and acceleration direction.

309: The interaction device sends the gesture triggered by the user based on the parameter information included in the graphical interaction interface to the controlling device through Wi-Fi.

310: After receiving the gesture which is triggered by the user based on the parameter information included in the graphical interaction interface and is sent by the interaction device, the controlling device parses the gesture to obtain attributes included in the gesture, and then identifies, according to the attributes included in the gesture, a control instruction corresponding to the parameter information included in the graphical interaction interface.

For example, the controlling device may determine, according to a touch operation area (including a touch operation start point and end point) attribute included in the content of the gesture, parameter information included in the graphical interaction interface included in the touch operation area, namely, parameter information which the user needs to control; further, the controlling device may also determine, according to an acceleration direction attribute included in the content of the gesture, a control type (such as increasing, decreasing, or changing a mode) of the parameter information which the user needs to control, so as to obtain a control instruction corresponding to the parameter information included in the graphical interaction interface.

In the embodiment of the present invention, through the foregoing steps 307 to 308, the objective, which is described in the foregoing embodiment, of obtaining a gesture triggered by the user based on the parameter information included in the graphical interaction interface can be achieved, while through the foregoing step 310, the objective, which is described in the foregoing embodiment, of parsing the gesture to obtain a control instruction corresponding to the parameter information included in the graphical interaction interface can be achieved.

311: The controlling device sends the control instruction triggered by the user based on the parameter information included in the graphical interaction interface to the controlled device through the USB interface.

312: The controlled device performs, in response to the control instruction, an adjustment corresponding to the parameter information included in the graphical interaction interface, so as to implement intelligent control on the controlled device.

In the embodiment of the present application, by running a device control service program on an intelligent operating system, a controlling device can perform the method for intelligently controlling a device described in FIG. 3. By implementing the method described in FIG. 3, a user does not need to perform related intelligent control on a controlled device by using an intelligent chip, a display screen, and/or complex keys that are integrated in the controlled device, and the user can perform intelligent control on the controlled device by triggering, on an interaction device, a gesture instruction corresponding to parameter information included in a graphical interactive interface displayed on the interaction device. In this way, intelligent control on the controlled device can be performed simply, conveniently, and fast.

In addition, by implementing the method described in FIG. 3, the controlled device only needs to have a basic function actuator and does not need to be integrated with an intelligent chip, a display screen, and complex keys. In this way, the user is allowed to have a relatively low intelligent control technology threshold, which greatly reduces a barrier to a user performing intelligent control, increases actual utilization of the controlled device, and benefits promotion and popularization of the controlled device.

Further, by implementing the method described in FIG. 3, the user can trigger, by using the interaction device, a controlled terminal to perform an intelligent operation at a fixed time and independently, so that the user no longer relies on the controlled device, thus the present application has good adaptability.

As described in the foregoing embodiment, a controlling device can perform the method for intelligently controlling a device described in FIG. 3 by running a device control service program on an intelligent operating system. Correspondingly, an embodiment of the present application further discloses a network architecture for upgrading a program. By using the network architecture for upgrading a program, a controlling device can download a device control service program from a cloud server and subsequently the controlling device can run the device control service program on an intelligent operating system, so as to perform the method for intelligently controlling a device described in FIG. 3.

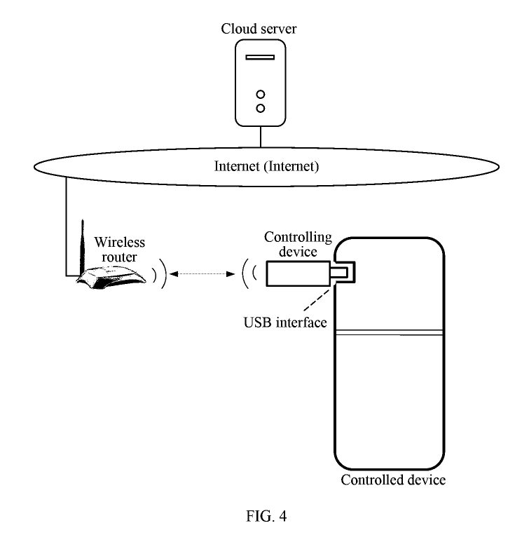

A schematic diagram of the network architecture for upgrading a program disclosed in the embodiment of the present application is shown in FIG. 4, where the network architecture includes a cloud server, a controlling device, a controlled device, and a wireless router. The controlling device accesses, preferably through a wireless manner (such as, Wi-Fi), a local area network where the wireless router is located, and the wireless router connects to the cloud server through the Internet, so as to establish a connection between the controlling device and the cloud server. In addition, the controlling device also establishes a connection to the controlled device (such as, a refrigerator) through a USB interface.

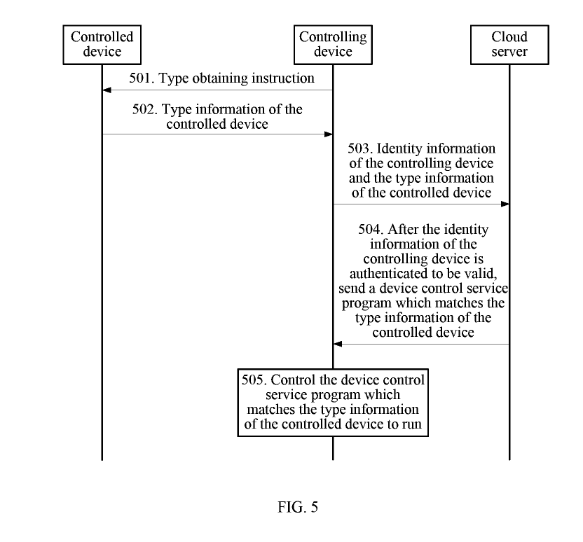

A flowchart of a method for downloading a device control service program to a controlling device by using the network architecture of FIG. 4 is shown in FIG. 5, and the method includes the following steps.

501: A controlling device sends a type acquiring instruction to a controlled device.

The type acquiring instruction is used for instructing the controlled device to acquire type information of the controlled device.

502: The controlled device sends the type information of the controlled device to the controlling device in response to the type acquiring instruction.

The type information of the controlled device may include information such as a device type, model information, or a device manufacturer of the controlled device.

503: The controlling device sends identity information of the controlling device and the type information of the controlled device to a cloud server.

504: After authenticating the identity information of the controlling device to be valid, the cloud server sends, to the controlling device, a device control service program matching with the type information of the controlled device.

In an embodiment, the cloud server may send, to the controlling device in a manner of a packet, the device control service program matching with the type information of the controlled device.

In an embodiment, after authenticating the identity information of the controlling device to be invalid, the cloud server may send an identity information authentication error message to the controlling device.

505: The controlling device controls the device control service program matching with the type information of the controlled device to run, so as to perform the method for intelligently controlling a device described in FIG. 3.

In an embodiment, after receiving the device control service program which matches with the type information of the controlled device and is sent by the cloud server, the controlling device may further install the device control service program matching with the type information of the controlled device.

By implementing the method described in FIG. 5, a controlling device can download a device control service program from a cloud server in a network architecture for upgrading a program as shown in FIG. 4, and can perform the method for intelligently controlling a device described in FIG. 3 by running the device control service program on an intelligent operating system. As a consequence, a user does not need to perform related intelligent control on a controlled device by using an intelligent chip, a display screen, and/or complex keys integrated in the controlled device, and can perform intelligent control on the controlled device by triggering, on an interaction device, a gesture instruction corresponding to parameter information included in a graphical interaction interface displayed on the interaction device. In this way, intelligent control on the controlled device can be performed simply, conveniently, and fast.

In addition, the controlled device only needs to have a basic function actuator, and does not need to be integrated with an intelligent chip, a display screen, and complex keys. In this way, the user is allowed to have a relatively low intelligent control technology threshold, which greatly reduces a barrier to a user performing intelligent control, increases actual utilization of the controlled device, and benefits promotion and popularization of the controlled device.

Further, the user can trigger, by using the interaction device, a controlled terminal to perform an intelligent operation at a fixed time and independently, so that the user no longer relies on the controlled device, thus the present application has good adaptability.

In an embodiment, before the controlling device downloads the device control service program from the cloud server in the network architecture for upgrading a program shown in FIG. 4, the controlling device may further first identify the controlled device by controlling a device identification service program to run After identifying the controlled device, the controlling device may start to perform the method described in FIG. 5, thereby implementing the downloading of the device control service program matching with the type information of the controlled device from the cloud server in the network architecture for upgrading a program shown in FIG. 4.

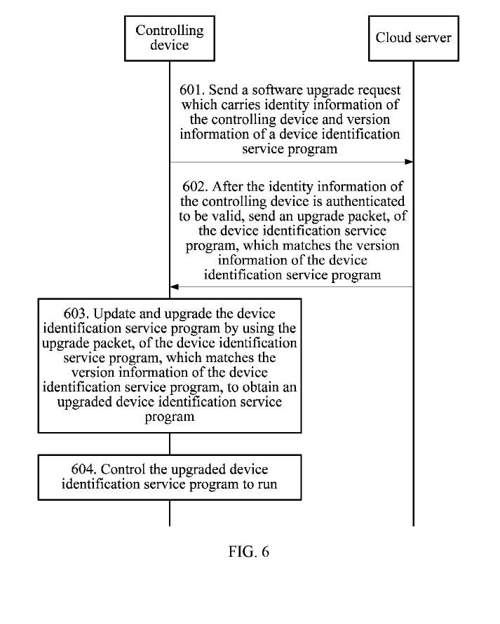

Correspondingly, an embodiment of the present application further discloses a method for updating a device identification service program to a controlling device by using the network architecture for upgrading a program shown in FIG. 4. A flowchart of the method is shown in FIG. 6, and the method includes the following steps.

601: A controlling device sends a software upgrade request which carries identity information of the controlling device and version information of a device identification service program to a cloud server.

602: After authenticating the identity information of the controlling device to be valid, the cloud server sends, to the controlling device, an upgrade packet of the device identification service program matching with the version information of the device identification service program.

In the embodiment of the present application, after the cloud server determines through authentication that the identity information of the controlling device is valid, the cloud server may further determine whether an upgrade packet of the device identification service program matching with the version information of the device identification service program is stored. If the upgrade packet of the device identification service program matching with the version information of the device identification service program is stored, the cloud server further sends, to the controlling device, the upgrade packet of the device identification service program matching with the version information of the device identification service program. If the upgrade packet of the device identification service program matching with the version information of the device identification service program is not stored, the cloud server determines that the device identification service program of the controlling device is of the latest version. In this case, the cloud server may also send, to the controlling device, a packet of the device identification service program matching with the version information of the device identification service program, as an upgrade packet of the device identification service program matching with the version information of the device identification service program.

603: After receiving the upgrade packet of the device identification service program matching with the version information of the device identification service program, the controlling device may update and upgrade the device identification service program by using the upgrade packet of the device identification service program matching with the version information of the device identification service program, to obtain an upgraded device identification service program, where the upgrade packet of the device identification service program is sent by the cloud server.

604: The controlling device controls the upgraded device identification service program to run, so as to perform the method described in FIG. 5 for downloading a device control service program to a controlling device by using the network architecture for upgrading a program shown in FIG. 4.

By implementing the method described in FIG. 6, a controlling device can update a device identification service program from a cloud server in a network architecture for upgrading a program, thereby performing the method described in FIG. 5 for downloading a device control service program to a controlling device by using the network architecture for upgrading a program shown in FIG. 4. In the embodiment of the present application, the controlling device can effectively identify more controlled devices by updating a device identification service program, so that an interaction device can subsequently perform intelligent control on more controlled devices simply, conveniently, and fast, which extends an application range of intelligent control.

In an embodiment, before a controlling device sends, to an interaction device, a graphical interaction interface which includes parameter information of a controlled device in a current state and is in a form of a data stream for display, the controlling device and the controlled device further need to establish a communication connection. For example, after both the controlling device and the controlled device access, through Wi-Fi, a local area network where a wireless router is located, the controlling device may send a broadcast packet; in this way, after the interaction device receives the broadcast packet sent by the controlling device, the interaction device may send a connection establishment request to the controlling device. After receiving the connection establishment request sent by the interaction device, the controlling device may send a connection completion response to the interaction device in response to the connection establishment request sent by the interaction device, so as to establish a communication connection between the controlling device and the controlled device.

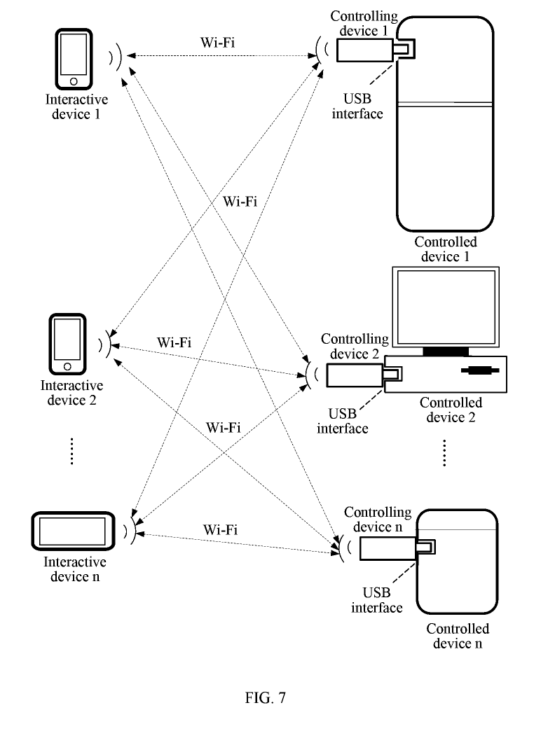

In the embodiment of the present application, an interaction device may simultaneously establish a communication connection to one or more controlling devices through Wi-Fi, while a controlling device generally can establish a communication connection to one controlled device through a USB interface. FIG. 7 is a schematic diagram of a network architecture for a communication connection according to an embodiment of the present application. In the network architecture for a communication connection shown in FIG. 7, controlling device 1 may establish a communication connection to controlled device 1 through a USB interface, controlling device 2 may establish a communication connection to controlled device 2 through a USB interface, . . . , the rest can be deduced by analogy, and controlling device n may establish a communication connection to controlled device n through a USB interface. While interaction device 1 may simultaneously establish a communication connection to one or more controlling devices of controlling device 1 to controlling device n through a wireless network (such as, Wi-Fi), interaction device 2 may also simultaneously establish a communication connection to one or more controlling devices from controlling device 1 to controlling device n through Wi-Fi, . . . , the rest can be deduced by analogy, and interaction device n may also simultaneously establish a communication connection to one or more controlling devices of controlling device 1 to controlling device n through Wi-Fi.

In the network architecture for a communication connection shown in FIG. 7, because the controlling devices and the controlled devices may each have a USB interface, a controlling device may also establish a communication connection to any one of the controlled devices through a USB interface while an interaction device may also establish a communication connection to any one of the controlling devices through Wi-Fi. Therefore, the controlling devices, the controlled devices, and the interaction devices can freely form a system for intelligently controlling a device, and a user can perform flexible and diversified intelligent control on a same controlled device or different controlled devices by using different interaction devices.

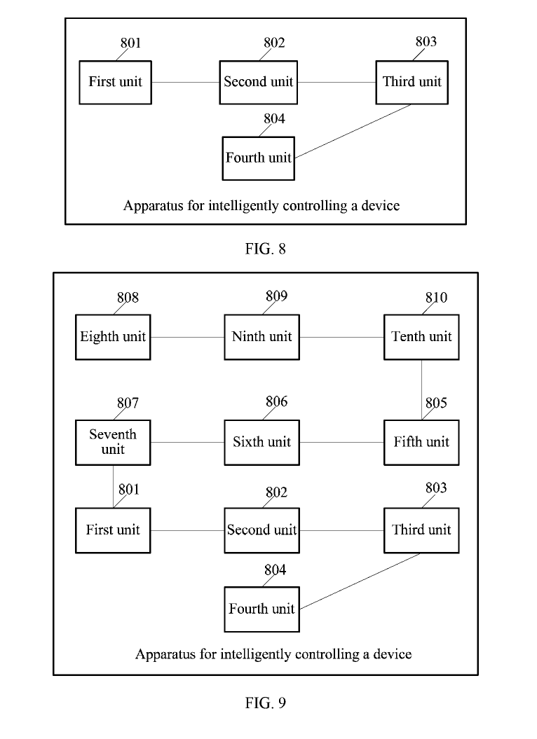

FIG. 8 is a simplified block diagram of an apparatus for intelligently controlling a device according to an embodiment of the present application, where the apparatus is configured to implement the method for intelligently controlling a device disclosed in the embodiments of the present application. It should be noted that in the embodiment of the present application, the apparatus for intelligently controlling a device shown in FIG. 8 may be used as an independent device to perform the method for intelligently controlling a device disclosed in the embodiments of the present application, or may also be used as a newly added part of a controlling device to perform the method for intelligently controlling a device disclosed in the embodiments of the present application. When the apparatus for intelligently controlling a device shown in FIG. 8 is used as an independent device or a newly added part of a controlling device to perform the method for intelligently controlling a device disclosed in the embodiments of the present application, the apparatus for intelligently controlling a device shown in FIG. 8 not only can establish a communication connection to a controlled device (such as, establishing a communication connection through a USB interface), but also can establish a communication connection to an interaction device (such as, establishing a communication connection to an interaction device through Wi-Fi).

In another implementation manner, the apparatus for intelligently controlling a device shown in FIG. 8 may also be a network element device having a function for intelligently controlling a device disclosed in the embodiments of the present application, where a product form of the network element device may be a home partner device, a router, a gateway device, a network firewall device, a gateway GPRS support node (GGSN), a packet data serving node (PDSN), or the like. It should be understood that the apparatus for intelligently controlling a device disclosed in the embodiment of the present application supports being independent and built externally, can interconnect to an existing device, or may also be built inside a network element device of a live network in a manner of a plug-in card or software integration.

As shown in FIG. 8, the apparatus for intelligently controlling a device disclosed in the embodiment of the present application includes:

a first unit 801, configured to acquire parameter information of a controlled device in a current state, where the parameter information reflects a current running state of the controlled device;

a second unit 802, configured to generate a graphical interaction interface including the parameter information acquired by the first unit 801;

a third unit 803, configured to send the graphical interaction interface in a form of a data stream to an interaction device for display; and

a fourth unit 804, configured to receive an input event sent by the interaction device, where the input event is triggered by a user based on the parameter information displayed on the graphical interaction interface of the interaction device; and parse the input event to obtain a control instruction corresponding to the parameter information included in the graphical interaction interface.

The third unit 803 is further configured to send the control instruction obtained by the fourth unit 804 to the controlled device, so that the controlled device performs, in response to the control instruction, a control operation corresponding to the current running state of the controlled device, where the performing a control operation corresponding to the current running state of the controlled device includes performing an adjustment corresponding to the parameter information included in the graphical interaction interface, thereby implementing intelligent control on the controlled device.

In the embodiment of the present application, a manner for the fourth unit 804 to parse the input event to obtain the control instruction corresponding to the parameter information included in the graphical interaction interface is specifically as follows:

the fourth unit 804 converts the input event into an input event matching with the graphical interaction interface generated by the controlling device, and parses the input event obtained through conversion to obtain the control instruction corresponding to the parameter information included in the graphical interaction interface.

In the embodiment of the present application, the fourth unit 804 may receive a gesture which is triggered by the user based on the parameter information included in the graphical interaction interface and is sent by the interaction device, and parse the gesture, to obtain the control instruction corresponding to the parameter information included in the graphical interaction interface.

By using the apparatus for intelligently controlling a device shown in FIG. 8, a user does not need to perform related intelligent control on a controlled device by using an intelligent chip, a display screen, and complex keys integrated in the controlled device; and the user can perform intelligent control on the controlled device only by triggering, on an interaction device, a gesture instruction corresponding to parameter information included in a graphical interaction interface displayed on the interaction device. In this way, intelligent control on the controlled device can be performed simply, conveniently, and fast.

In addition, by using the apparatus for intelligently controlling a device shown in FIG. 8, the controlled device only needs to have a basic function actuator and does not need to be integrated with an intelligent chip, a display screen, and complex keys. In this way, the user is allowed to have a relatively low intelligent control technology threshold, which greatly reduces a barrier to a user performing intelligent control, increases actual utilization of the controlled device, and benefits promotion and popularization of the controlled device.

Further, by using the apparatus for intelligently controlling a device shown in FIG. 8, the user can trigger, by using the interaction device, a controlled terminal to perform an intelligent operation at a fixed time and independently, so that the user no longer relies on the controlled device, thus the present application has good adaptability.

FIG. 9 is a simplified block diagram of another apparatus for intelligently controlling a device according to an embodiment of the present application, where the apparatus is configured to implement the method for intelligently controlling a device disclosed in the embodiments of the present application. The apparatus for intelligently controlling a device shown in FIG. 9 is obtained by optimizing the apparatus for intelligently controlling a device shown in FIG. 8. Besides the units included in the apparatus for intelligently controlling a device shown in FIG. 8, the apparatus for intelligently controlling a device shown in FIG. 9 may further include:

a fifth unit 805, configured to send a type acquiring instruction to the controlled device, and receive type information of the controlled device which is sent by the controlled device in response to the type acquiring instruction;

a sixth unit 806, configured to send, to a cloud server, identity information of the local end and the type information of the controlled device which is received by the fifth unit 805, and receive a device control service program, which matches with the type information of the controlled device and is sent by the cloud server after the cloud server authenticates the identity information of the local end to be valid, where the device control service program is used to control a device through performing; and

a seventh unit 807, configured to control the device control service program which matches with the type information of the controlled device and is received by the sixth unit 806 to run, so as to trigger the first unit 801 to perform the operation of acquiring the parameter information of the controlled device in the current state.

In an embodiment, the apparatus for intelligently controlling a device shown in FIG. 9 further includes:

an eighth unit 808, configured to send a software upgrade request which carries the identity information of the local end and version information of a device identification service program to the cloud server, and receive an upgrade packet of the device identification service program matching with the version information of the device identification service program, where the upgrade packet of the device identification service program is sent by the cloud server after the cloud server authenticates the identity information of the local end to be valid;

a ninth unit 809, configured to update and upgrade the device identification service program by using the upgrade packet of the device identification service program matching with the version information of the device identification service program, to obtain an upgraded device identification service program, where the device identification service program is used to identify a device type through performing, and the upgrade packet of the device identification service program is received by the eighth unit 808; and

a tenth unit 810, configured to control the upgraded device identification service program obtained by the ninth unit 809 to run, so as to trigger the fifth unit 805 to perform the operation of sending the type acquiring instruction to the controlled device.

In an embodiment, in the apparatus for intelligently controlling a device shown in FIG. 8 or FIG. 9, the third unit 803 is further configured to receive a connection establishment request sent by the interaction device, and send a connection completion response corresponding to the connection establishment request to the interaction device in response to the connection establishment request sent by the interaction device, so as to establish a communication connection between the apparatus for intelligently controlling a device and the interaction device.

In an embodiment, in the apparatus for intelligently controlling a device shown in FIG. 8 or FIG. 9, the first unit 801 is configured to send a parameter information query to the controlled device, and receive the parameter information of the controlled device in the current state which is sent by the controlled device in response to the parameter information query, so as to obtain the parameter information of the controlled device in the current state.

In an embodiment, in the apparatus for intelligently controlling a device shown in FIG. 8 or FIG. 9, a specific manner for the third unit 803 to send the graphical interaction interface in the form of a data stream to the interaction device for display is as follows:

the third unit 803 is configured to encode the graphical interaction interface into a video stream of a graphical interaction interface, and send the video stream of the graphical interaction interface to the interaction device, so that the interaction device decodes the video stream of the graphical interaction interface after receiving the video stream of the graphical interaction interface, renders, for display, the video stream of the decoded graphical interaction interface into the graphical interaction interface including the parameter information of the controlled device in the current state.

By using the apparatus for intelligently controlling a device shown in FIG. 9, a user does not need to perform related intelligent control on a controlled device by using an intelligent chip, a display screen, and complex keys integrated in the controlled device; and the user can perform intelligent control on the controlled device only by triggering, on an interaction device, a gesture instruction corresponding to parameter information included in a graphical interaction interface displayed on the interaction device. In this way, intelligent control on the controlled device can be performed simply, conveniently, and fast.

In addition, by using the apparatus for intelligently controlling a device shown in FIG. 9, the controlled device only needs to have a basic function actuator and does not need to be integrated with an intelligent chip, a display screen, and complex keys. In this way, the user is allowed to have a relatively low intelligent control technology threshold, which greatly reduces a barrier to a user performing intelligent control, increases actual utilization of the controlled device, and benefits promotion and popularization of the controlled device.

Further, by using the apparatus for intelligently controlling a device shown in FIG. 9, the user can trigger, by using the interaction device, a controlled terminal to perform an intelligent operation at a fixed time and independently, so that the user no longer relies on the controlled device, thus the present application has good adaptability.

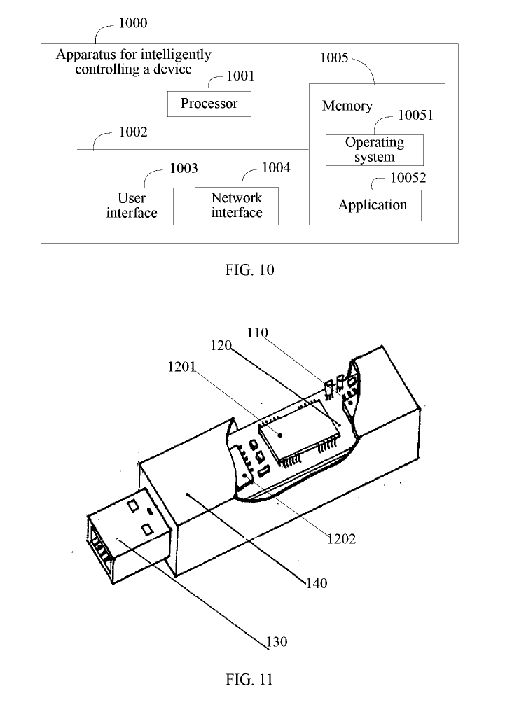

FIG. 10 is a structural diagram of another apparatus for intelligently controlling a device according to an embodiment of the present application, where the apparatus is configured to perform the method for intelligently controlling a device disclosed in the embodiments of the present application. As shown in FIG. 10, the apparatus for intelligently controlling a device 1000 includes at least one processor 1001, such as, a central processing unit (CPU), at least one network interface 1004 or another interaction interface 1003, a memory 1005, and at least one communication bus 1002. The communication bus 1002 is configured to implement communication connections between these components. The interaction interface 1003 may optionally include but is not limited to a USB interface or another standard interface or wired interface. The network interface 1004 may optionally include a Wi-Fi interface or another wireless interface. The memory 1005 may be a high-speed random access memory (RAM), or may further include a non-volatile memory, such as, a disk memory. The memory 1005 may optionally include at least one storage apparatus located far away from the processor 1001.

In some implementation manners, the memory 1005 stores the following elements, executable modules, or a data structure, a subset of the following elements, the executable modules, and the data structure, or an extension set of the following elements, the executable modules, and the data structure:

an operating system 10051, including various system programs which are used for implementing various basic services and processing a task based on hardware; and

an application system 10052, including various applications such as a device control service program and a device identification service program which are used for implementing various application services.

Specifically, the processor 1001 is configured to invoke a program stored in the memory 1005 to perform the following operations:

acquiring parameter information of a controlled device in a current state, where the parameter information is used for reflecting a current running state of the controlled device;

generating a graphical interaction interface including the parameter information of the controlled device in the current state, and sending the graphical interaction interface in a form of a data stream to an interaction device for display;

receiving an input event sent by the interaction device, where the input event is triggered by a user based on the parameter information displayed on the graphical interaction interface of the interaction device;

parsing the input event to obtain a control instruction corresponding to the parameter information included in the graphical interaction interface; and

sending the control instruction to the controlled device, so that the controlled device performs, in response to the control instruction, a control operation corresponding to the current running state of the controlled device, where the performing a control operation corresponding to the current running state of the controlled device includes performing an adjustment corresponding to the parameter information included in the graphical interaction interface.

In an embodiment, a manner for the processor 1001 to parse the input event to obtain the control instruction corresponding to the parameter information included in the graphical interaction interface is specifically as follows:

the processor 1001 converts the input event into an input event matching with the graphical interaction interface generated by the controlling device, and parses the input event obtained through conversion to obtain the control instruction corresponding to the parameter information included in the graphical interaction interface.

In an embodiment, before acquiring the parameter information of the controlled device in the current state, the processor 1001 may also perform the following operations:

sending a type acquiring instruction to the controlled device, and receiving type information of the controlled device which is sent by the controlled device in response to the type acquiring instruction;

sending identity information of the local end (that is, the apparatus for intelligently controlling a device) and the type information of the controlled device to a cloud server, and receiving a device control service program, which matches with the type information of the controlled device and is sent by the cloud server after the cloud server authenticates the identity information of the local end to be valid; and

controlling the device control service program matching with the type information of the controlled device to run, so as to trigger performing of the step of acquiring parameter information of a controlled device in a current state.

In an embodiment, before sending the type acquiring instruction to the controlled device, the processor 1001 may also perform the following operations:

sending a software upgrade request which carries the identity information of the local end and version information of a device identification service program to the cloud server, and receiving an upgrade packet of the device identification service program matching with the version information of the device identification service program, where the upgrade packet of the device identification service program is sent by the cloud server after the cloud server authenticates the identity information of the local end to be valid;

updating and upgrading the device identification service program by using the upgrade packet of the device identification service program matching with the version information of the device identification service program, to obtain an upgraded device identification service program; and

controlling the upgraded device identification service program to run, so as to trigger performing of the step of sending a type acquiring instruction to the controlled device.

In an embodiment, before sending the graphical interaction interface in the form of a data stream to the interaction device for display, the processor 1001 also performs the following operations:

receiving a connection establishment request sent by the interaction device, and sending a connection completion response corresponding to the connection establishment request to the interaction device in response to the connection establishment request sent by the interaction device.

In an embodiment, the acquiring, by the processor 1001, parameter information of a controlled device in a current state includes:

sending, by the processor 1001, a parameter information query to the controlled device, and receiving the parameter information of the controlled device in the current state which is sent by the controlled device in response to the parameter information query.

In an embodiment, the sending, by the processor 1001, the graphical interaction interface in a form of a data stream to an interaction device for display includes:

encoding, by the processor 1001, the graphical interaction interface into a video stream of the graphical interaction interface, and sending the video stream of the graphical interaction interface to the interaction device, so that the interaction device decodes the video stream of the graphical interaction interface after receiving the video stream of the graphical interaction interface, renders the decoded video stream of the graphical interaction interface into the graphical interaction interface for display.

By using the apparatus for intelligently controlling a device shown in FIG. 10, a user does not need to perform related intelligent control on a controlled device by using an intelligent chip, a display screen, and complex keys integrated in the controlled device; and the user can perform intelligent control on the controlled device only by triggering, on an interaction device, a gesture instruction corresponding to parameter information included in a graphical interaction interface displayed on the interaction device. In this way, intelligent control on the controlled device can be performed simply, conveniently, and fast.

In addition, by using the apparatus for intelligently controlling a device shown in FIG. 10, the controlled device only needs to have a basic function actuator and does not need to be integrated with an intelligent chip, a display screen, and complex keys. In this way, the user is allowed to have a relatively low intelligent control technology threshold, which greatly reduces a barrier to a user performing intelligent control, increases actual utilization of the controlled device, and benefits promotion and popularization of the controlled device.

Further, by using the apparatus for intelligently controlling a device shown in FIG. 10, the user can trigger, by using the interaction device, a controlled terminal to perform an intelligent operation at a fixed time and independently, so that the user no longer relies on the controlled device, thus the present application has good adaptability.

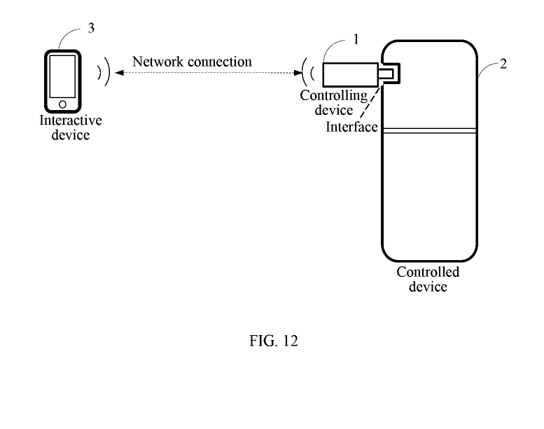

FIG. 11 is a structural diagram of a plug-and-play device according to an embodiment of the present application. As shown in FIG. 11, the plug-and-play device includes a radio frequency module 110, a circuit board 120, and a universal serial bus interface module 130, where a microcontroller 1201 and a memory 1202 are disposed on the circuit board 120, the radio frequency module 110 and the universal serial bus interface module 130 are each in a communication connection to the microcontroller 1201 through a circuit, the microcontroller 1201 is in a communication connection to the memory 1202 through a circuit, and the circuit board 120 and the radio frequency module 110 are completely accommodated in a single casing 140;

the memory 1202 is configured to store program instructions, and the program instructions are used for performing intelligent control on a controlled device;

the microcontroller 1201 is configured to invoke the program instructions stored in the memory 1202 to perform the following operations:

acquiring parameter information of the controlled device in a current state by using the universal serial bus interface module 130, where the parameter information reflects a current running state of the controlled device; generating a graphical interaction interface including the parameter information, and sending, by using the radio frequency module 110, the graphical interactive interface in a form of a data stream to an interaction device for display; receiving, by using the radio frequency module 110, an input event sent by the interaction device, where the input event is triggered by a user based on the parameter information displayed on the graphical interactive interface of the interaction device; parsing the input event to obtain a control instruction corresponding to the parameter information included in the graphical interactive interface; and sending the control instruction to the controlled device by using the universal serial bus interface module 130, so that the controlled device performs, in response to the control instruction, a control operation corresponding to the current running state of the controlled device, where the performing a control operation corresponding to the current running state of the controlled device includes performing an adjustment corresponding to the parameter information included in the graphical interactive interface.

In an embodiment, in the parsing, by the microcontroller 1201, the input event to obtain the control instruction corresponding to the parameter information included in the graphical interactive interface,

the microcontroller 1201 is specifically configured to convert the input event into an input event matching with the generated graphical interaction interface, and parse the input event obtained through conversion to obtain the control instruction corresponding to the parameter information included in the graphical interaction interface.

In an embodiment, the microcontroller 1201 is further configured to send a type acquiring instruction to the controlled device by using the universal serial bus interface module 130, and receive type information of the controlled device which is sent by the controlled device in response to the type acquiring instruction by using the universal serial bus interface module 130; send identity information of the local device (that is, the plug-and-play device) and the type information of the controlled device to a cloud server by using the radio frequency module 110, and receive, by using the radio frequency module 110, a device control service program, which matches with the type information of the controlled device and is sent by the cloud server after the cloud server authenticates the identity information of the local device to be valid; and control the device control service program matching with the type information of the controlled device to run, so as to trigger performing of the step of acquiring, by using the universal serial bus interface module 130, the parameter information of the controlled device in the current state.

In an embodiment, the microcontroller 1201 is further configured to send, by using the radio frequency module 110, a software upgrade request which carries the identity information of the local device and version information of a device identification service program to the cloud server, and receive, by using the radio frequency module 110, an upgrade packet of the device identification service program matching with the version information of the device identification service program, where the upgrade packet of the device identification service program is sent by the cloud server after the cloud server authenticates the identity information of the local device to be valid; update and upgrade the device identification service program by using the upgrade packet of the device identification service program matching with the version information of the device identification service program, to obtain an upgraded device identification service program; and control the upgraded device identification service program to run, so as to trigger performing of the step of sending, by using the universal serial bus interface module 130, the type acquiring instruction to the controlled device.

In an embodiment, the microcontroller 1201 is further configured to receive, by using the radio frequency module 110, a connection establishment request sent by the interaction device, and send, by using the radio frequency module 110, a connection completion response corresponding to the connection establishment request to the interaction device in response to the connection establishment request sent by the interaction device.

In an embodiment, in the acquiring, by the microcontroller 1201, parameter information of the controlled device in a current state by using the universal serial bus interface module 130,

the microcontroller 1201 is specifically configured to send a parameter information query to the controlled device by using the universal serial bus interface module 130, and receive, by using the universal serial bus interface module 130, the parameter information of the controlled device in the current state which is sent by the controlled device in response to the parameter information query.

In an embodiment, in the sending, by the microcontroller 1201 by using the radio frequency module 110, the graphical interaction interface in a form of a data stream to an interaction device for display,

the microcontroller 1201 is specifically configured to encode the graphical interaction interface into a video stream of the graphical interaction interface, and send the video stream of the graphical interaction interface to the interaction device by using the radio frequency module 110, so that the interaction device decodes the video stream of the graphical interaction interface after receiving the video stream of the graphical interaction interface, renders the decoded video stream of the graphical interaction interface into the graphical interaction interface for display.

By using the plug-and-play device shown in FIG. 11, a user does not need to perform related intelligent control on a controlled device by using an intelligent chip, a display screen, and complex keys integrated in the controlled device; and the user can perform intelligent control on the controlled device only by triggering, on an interaction device, a gesture instruction corresponding to parameter information included in a graphical interaction interface displayed on the interaction device. In this way, intelligent control on the controlled device can be performed simply, conveniently, and fast.

In addition, by using the plug-and-play device shown in FIG. 11, the controlled device only needs to have a basic function actuator and does not need to be integrated with an intelligent chip, a display screen, and complex keys. In this way, the user is allowed to have a relatively low intelligent control technology threshold, which greatly reduces a barrier to a user performing intelligent control, increases actual utilization of the controlled device, and benefits promotion and popularization of the controlled device.

Further, by using the plug-and-play device shown in FIG. 11, the user can trigger, by using the interaction device, a controlled terminal to perform an intelligent operation at a fixed time and independently, so that the user no longer relies on the controlled device, thus the present application has good adaptability.

It should be noted that the plug-and-play device mentioned in the embodiment of the present application may also be called as a controlling device or an apparatus for intelligently controlling a device; and in an implementation manner, a controlling device or an apparatus for intelligently controlling a device is the plug-and-play device mentioned in the embodiment of the present application.

FIG. 12 is a structural diagram of a system for intelligently controlling a device according to an embodiment of the present application, where the system is configured to perform the method for intelligently controlling a device disclosed in the embodiments of the present application. As shown in FIG. 12, the system for intelligently controlling a device includes a controlling device 1, a controlled device 2, and an interaction device 3. In an implementation manner, the controlling device 1 may establish a communication connection to the controlled device 2 through an interface (such as, a USB interface), and the controlling device 1 may establish a communication connection to the interaction device 3 through a network connection (which includes but is not limited to a wireless connection or a wired connection, such as, Wi-Fi), where:

the controlling device 1 is configured to acquire parameter information of the controlled device 2 in a current state, where the parameter information is used for reflecting a current running state of the controlled device 2; generate a graphical interaction interface including the parameter information of the controlled device 2 in the current state; send the graphical interaction interface in a form of a data stream to the interaction device 3 for display; receive an input event (such as, a gesture) sent by the interaction device 3, where the input event is triggered by a user based on the parameter information displayed on the graphical interaction interface of the interaction device 3; parse the input event to obtain a control instruction corresponding to the parameter information included in the graphical interaction interface; and send the control instruction to the controlled device 2;

the controlled device 2 is configured to perform, in response to the control instruction, a control operation corresponding to the current running state of the controlled device 2, where the performing a control operation corresponding to the current running state of the controlled device 2 includes performing an adjustment corresponding to the parameter information included in the graphical interaction interface; and

the interaction device 3 is configured to receive and display the graphical interaction interface which includes the parameter information of the controlled device 2 in the current state and is sent by the controlling device 1, and send, to the controlling device 1, the input event (such as, the gesture) triggered by the user based on the parameter information displayed on the graphical interaction interface of the interaction device 3.

In an embodiment, a manner for the controlling device 1 to parse the input event to obtain the control instruction corresponding to the parameter information included in the graphical interaction interface is specifically as follows:

the controlling device 1 is configured to convert the input event into an input event matching with the graphical interaction interface generated by the controlling device 1, and parse the input event obtained through conversion to obtain the control instruction corresponding to the parameter information included in the graphical interaction interface.

In an embodiment, the system for intelligently controlling a device shown in FIG. 12 further includes a cloud server 4, where:

the controlling device 1 is further configured to send a type acquiring instruction to the controlled device 2, receive type information of the controlled device 2 which is sent by the controlled device 2 in response to the type acquiring instruction, and send identity information of the controlling device 1 and the type information of the controlled device 2 to the cloud server 4;

the cloud server 4 is configured to receive the identity information of the controlling device 1 and the type information of the controlled device 2 which are sent by the controlling device 1, and send a device control service program matching with the type information of the controlled device 2 to the controlling device 1 after authenticating the identity information of the controlling device 1 to be valid;

correspondingly, the controlling device 1 is further configured to receive and control the device control service program matching with the type information of the controlled device 2 to run, so as to trigger performing of the operation of acquiring the parameter information of the controlled device 2 in the current state; and

correspondingly, the controlled device 2 is further configured to receive the type acquiring instruction sent by the controlling device 1, and send the type information of the controlled device 2 to the controlling device 1 in response to the type acquiring instruction.

In an embodiment, in the system for intelligently controlling a device shown in FIG. 12, the controlling device 1 is further configured to send a software upgrade request which carries identity information of the controlling device 1 and version information of a device identification service program to the cloud server 4, and receive an upgrade packet of the device identification service program matching with the version information of the device identification service program, where the upgrade packet of the device identification service program is sent by the cloud server 4 after the cloud server 4 authenticates the identity information of the controlling device 1 to be valid; update and upgrade the device identification service program by using the upgrade packet of the device identification service program matching with the version information of the device identification service program, to obtain an upgraded device identification service program; and control the upgraded device identification service program to run, so as to trigger performing of the operation of sending the type acquiring instruction to the controlled device 2; and

correspondingly, the cloud server 4 is further configured to receive the software upgrade request which carries the identity information of the controlling device 1 and the version information of the device identification service program and is sent by the controlling device 1, and send, to the controlling device 1, the upgrade packet of the device identification service program matching with the version information of the device identification service program after authenticating the identity information of the controlling device 1 to be valid.

In an embodiment, in the system for intelligently controlling a device shown in FIG. 12, the controlling device 1 is further configured to receive a connection establishment request sent by the interaction device 3 and send a connection completion response corresponding to the connection establishment request to the interaction device 3 in response to the connection establishment request sent by the interaction device 3; and

correspondingly, the interaction device 3 is further configured to send the connection establishment request to the controlling device 1 and receive the connection completion response, which is sent by the controlling device 1 in response to the connection establishment request, so as to establish a communication connection between the controlling device 1 and the interaction device 3.

In an embodiment, in the system for intelligently controlling a device shown in FIG. 12, a specific manner for the controlling device 1 to acquire the parameter information of the controlled device in the current state is as follows:

the controlling device 1 is configured to send a parameter information query to the controlled device 2, and receive the parameter information of the controlled device in the current state which is sent by the controlled device 2 in response to the parameter information query; and

correspondingly, the controlled device 2 is further configured to receive the parameter information query sent by the controlling device 1, and send the parameter information of the controlled device in the current state to the controlling device 1 in response to the parameter information query.

In an embodiment, in the system for intelligently controlling a device shown in FIG. 12, a specific manner for the controlling device 1 to send the graphical interaction interface in the form of a data stream to the interaction device 3 for display is as follows:

that the controlling device 1 is configured to encode the graphical interaction interface into a video stream of the graphical interaction interface, and send the video stream of the graphical interaction interface to the interaction device 3; and

the interaction device 3 is configured to receive the video stream of the graphical interaction interface sent by the controlling device 1, decode the video stream of the graphical interaction interface, render, for display, the decoded video stream of the graphical interaction interface into the graphical interaction interface including the parameter information of the controlled device 2 in the current state.

In the system for intelligently controlling a device shown in FIG. 12, a user does not need to perform related intelligent control on a controlled device by using an intelligent chip, a display screen, and complex keys integrated in the controlled device; and the user can perform intelligent control on the controlled device only by triggering, on an interaction device, a gesture instruction corresponding to parameter information included in a graphical interaction interface displayed on the interaction device. In this way, intelligent control on the controlled device can be performed simply, conveniently, and fast.

In addition, in the system for intelligently controlling a device shown in FIG. 12, the controlled device only needs to have a basic function actuator and does not need to be integrated with an intelligent chip, a display screen, and complex keys. In this way, a user is allowed to have a relatively low intelligent control technology threshold, which greatly reduces a barrier to a user performing intelligent control, increases actual utilization of the controlled device, and benefits promotion and popularization of the controlled device.

Further, in the system for intelligently controlling a device shown in FIG. 12, the user can trigger, by using the interaction device, a controlled terminal to perform an intelligent operation at a fixed time and independently, so that the user no longer relies on the controlled device, thus the present application has good adaptability.

An embodiment of the present application further discloses a computer storage medium. The computer storage medium stores a computer program, and when the computer program in the computer storage medium is read into a computer, the computer can complete all the steps of the method for intelligently controlling a device disclosed in the embodiments of the present application.

A person of ordinary skill in the art may understand that all or a part of the steps of the methods in the embodiments may be implemented by a program instructing relevant hardware (such as a processor). The program may be stored in a computer readable storage medium. The storage medium may include: a flash memory, a read-only memory (ROM), a random access memory (RAM), a magnetic disk, or an optical disc.

The method, the apparatus, and the system for intelligently controlling a device disclosed in the embodiments of the present application are introduced above in detail, and the principle and implementation manners of the present application are described herein by using specific examples. The above descriptions of the embodiments are merely for understanding the method and core ideas of the present application. Meanwhile, a person of ordinary skill in the art may make modifications to the specific implementation manners and application ranges according to the idea of the present application. In conclusion, the content of the specification shall not be regarded as a limitation to the present application.

What is claimed is:

1. A method, comprising:
acquiring, by a controlling device, parameter information of a controlled device, wherein the parameter information reflects a current running state of the controlled device;
generating, by the controlling device, a graphical user interface (GUI), wherein the acquired parameter information is integrated in the GUI;
converting the GUI into a data stream;
sending the data stream to an interaction device for displaying the GUI and the parameter information on the interaction device;
receiving, by the controlling device, a signal from the interaction device, wherein the signal is generated based on an input by a user on the interaction device for performing a control operation on the controlled device;
parsing, by the controlling device, the signal to obtain an instruction; and
sending, by the controlling device, the instruction to the controlled device, so that the controlled device performs the control operation according to the instruction.

2. The method according to claim 1, wherein
the GUI and the parameter information are displayed on an interactive graphical display unit of the interaction device;
the input by the user is received on the interactive graphical display unit and the input comprises an instruction for adjusting the parameter information of the controlled device; and
the control operation comprises an operation of adjusting the parameter information of the controlled device.

3. The method according to claim 1, wherein parsing the signal to obtain an instruction comprises:
converting, by the controlling device, the signal into an input event matching with the user input on the interaction device, and parsing the input event to obtain the instruction.

4. The method according to claim 1, further comprising:
acquiring, by the controlling device, type information of the controlled device;
sending, by the controlling device, identity information of the controlling device and the type information of the controlled device to a cloud server;
receiving, by the controlling device, a device control program corresponding to the type information of the controlled device after the cloud server determines through an authentication that the identity information of the controlling device is valid; and
installing, by the controlling device, the device control program.

5. The method according to claim 4, further comprising:
sending, by the controlling device, a software upgrade request which carries the identity information of the controlling device and version information of the device control program to the cloud server;
receiving, by the controlling device, an upgrade packet of the device control program, wherein the upgrade packet of the device control program is sent by the cloud server after the cloud server determines that the device control program installed in the controlling device is not the latest version; and
upgrading, by the controlling device, the device control program by using the upgrade packet.

6. The method according to claim 1, further comprising:
receiving, by the controlling device, a connection establishment request from the interaction device; and
sending, by the controlling device, a connection completion response to the interaction device so as to establish a connection between the controlling device and the interaction device.

7. The method according to claim 1, wherein acquiring the parameter information of the controlled device comprises:
sending, by the controlling device, a parameter information query to the controlled device; and
receiving, by the controlling device, the parameter information of the controlled device from the controlled device in response to the parameter information query.

8. The method according to claim 1, wherein converting the GUI into a data stream comprises:
encoding, by the controlling device, the GUI into an encoded video data stream; and wherein sending the data stream to an interaction device for displaying the GUI and the parameter information on the interaction device comprises:
sending the encoded video data stream to the interaction device, so that the interaction device decodes the encoded video data stream, and renders the decoded video data stream into a displayed GUI for displaying on the interaction device.

9. A controlling device, comprising:
a first connection interface for connecting to a controlled device;
a second connection interface for connecting to an interaction device;
a memory unit for storing program codes; and
at least one processor, executing program codes stored in the memory unit,
wherein:
the first connection interface is configured to receive parameter information of the controlled device, wherein the parameter information reflects a current running state of the controlled device;
the processor is configured to generate a graphical user interface (GUI), wherein the parameter information is integrated in the GUI, and convert the GUI into a data stream;
the second connection interface is configured to send the data stream to the interaction device for displaying the GUI and the parameter information on the interaction device, and to receive a signal from the interaction device, wherein the signal is generated based on an input by a user on the interaction device for performing a control operation on the controlled device;
the processor is further configured to parse the signal to obtain an instruction; and
the first connection interface is further configured to send the instruction to the controlled device, so that the controlled device performs the control operation according to the instruction.

10. The controlling device according to claim 9, wherein
the GUI and the parameter information are displayed on an interactive graphical display unit of the interaction device;
the input by the user is received on the interactive graphical display unit and the input comprises an instruction for adjusting the parameter information of the controlled device; and
the control operation comprises an operation of adjusting the parameter information of the controlled device.

11. The controlling device according to claim 9, wherein in parsing the signal to obtain the instruction, the processor is configured to:
convert the signal into an input event matching with the user input on the interaction device, and parse the input event to obtain the instruction.

12. The controlling device according to claim 9, wherein the controlling device is further connected to a cloud server through the interaction device,
the first connection interface is further configured to obtain type information of the controlled device;
the second connection interface is further configured to send identity information of the controlling device and the type information of the controlled device to the cloud server through the interaction device, and to receive a device control program corresponding to the type information of the controlled device sent by the cloud server after the cloud server determines through an authentication that the identity information of the controlling device is valid; and
the processor is further configured to installing the device control program.

13. The controlling device according to claim 9, wherein
the second connection interface is further configured to send a software upgrade request which carries the identity information of the controlling device and version information of the device control program to the cloud server through the interaction device, and to receive an upgrade packet of the device control program, wherein the upgrade packet of the device control program is sent by the cloud server after the cloud server determines that the device control program installed in the controlling device is not the latest version; and
the processor is further configured to upgrade the device control program by using the upgrade packet.

14. The controlling device according to claim 9, wherein
the second connection interface is further configured to receive a connection establishment request from the interaction device, and to send a connection completion response to the interaction device so as to establish a connection between the controlling device and the interaction device.

15. The controlling device according to claim 9, wherein the first connection interface is further configured to send a parameter information query to the controlled device, and the parameter information of the controlled device is received in response to the parameter information query.

16. The controlling device according to claim 9,
wherein in converting the GUI into a data stream, the processor is configured to encode the GUI into an encoded video data stream; and
and wherein in sending the data stream to the interaction device for displaying the GUI and the parameter information on the interaction device, the second connection interface is configured to send the encoded video data stream to the interaction device, so that the interaction device decodes the encoded video data stream, and renders the decoded video data stream into the GUI for displaying on the interaction device.

17. The controlling device according to claim 9, wherein the controlling device is a plug-and-play device that is coupled with the controlled device via the first connection interface.

18. The controlling device according to claim 9, wherein the second connection interface is a wireless connection interface.

19. A system, comprising a controlling device, a controlled device, and an interaction device, wherein:
the controlling device is configured to acquire parameter information of the controlled device, generate a graphical user interface (GUI), convert the GUI into a data stream, and send the data stream to the interaction device, wherein the parameter information reflects a current running state of the controlled device, and the parameter information is integrated in the GUI;
the interaction device is configured to receive the data stream, display the GUI and the parameter information on the interaction device, receive a user input comprising an instruction for performing an control operation on the controlled device, and send a signal comprising the user input to the controlling device;
the controlling device is further configured to receive the signal from the interaction device, parse the signal to obtain the instruction, and send the instruction to the controlled device; and
the controlled device is configured to perform the control operation according to the instruction.

20. The system according to claim 19, wherein in parsing the signal to obtain the instruction, the controlling device is configured to:
convert the signal into an input event matching with the user input on the interaction device, and parse the input event to obtain the instruction.

21. The system according to claim 19, further comprising a cloud server, wherein:
the controlling device is further configured to acquire type information of the controlled device, and send the identity information of the controlling device and the type information of the controlled device to the cloud server;
the cloud server is configured to authenticate the identity of the controlling device, and send a device control program corresponding to the type information of the controlled device; and
the controlling device is further configured to install the device control program.

22. The system according to claim 21, wherein:
the controlling device is further configured to send a software upgrade request which carries the identity information of the controlling device and version information of the device control program to the cloud server;
the cloud server is configured to send an upgrade packet of the device control program to the controlling device, wherein the upgrade packet of the device control program is sent by the cloud server after the cloud server determines that the device control program installed in the controlling device is not the latest version; and
the controlling device is further configured to upgrade the device control program by using the upgrade packet.
